(19) United States
(12) Patent Application Publication
(10) Pub. No.: US 2013/0063474 A1
(43) Pub. Date: Mar. 14, 2013

(54) MULTI-PRIMARY COLOR LCD AND COLOR SIGNAL CONVERSION DEVICE AND METHOD THEREOF

(71) Applicant: Chia-Hsin Chen, Taipei City (TW)

(72) Inventor: Chia-Hsin Chen, Taipei City (TW)

(73) Assignee: BEYOND INNOVATION TECHNOLOGY CO., LTD., Taipei City (TW)

(21) Appl. No.: 13/541,642

(22) Filed: Jul. 3, 2012

(30) Foreign Application Priority Data
Sep. 8, 2011 (TW) 100132434

(51) Int. Cl. G09G 5/02

(52) U.S. Cl. 345/604

(57) ABSTRACT

A color signal conversion method suitable for a multi-primary color LCD is provided, which includes converting an RGB (red, green, blue) color input signal into a YUV (brightness-chroma) color signal; performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal of the RGB color input signal; and converting the compensated YUV color signal into an RGB color output signal.

### CROSS-REFERENCE TO RELATED APPLICATION

This application claims the priority benefit of Taiwan application serial no. 100132434, filed on Sep. 8, 2011. The entirety of the above-mentioned patent application is hereby incorporated by reference herein and made a part of this specification.

### BACKGROUND OF THE INVENTION

1. Field of the Invention

The invention is related to a flat panel display technology, and more particularly, to a multi-primary color LCD and a color signal conversion device and method thereof.

2. Description of Related Art

In development of LCD monitors, the demand for high brightness has become more and more critical. In order to achieve high brightness, a driving current may be added to allow a backlight module to provide a backlight source with higher brightness, or an aperture ratio (AR) of pixels may be improved in a pixel design. However, regarding the former, system power consumption may considerably increase as a result; regarding the latter, there are design limitations on improvement of aperture ratio, and problems such as circuit parasitic effects and process variations may easily be caused.

To improve the above-mentioned disadvantages, multi-primary color LCDs are developed accordingly, which additionally add a W (white) sub-pixel to a single pixel traditionally consisting of RGB (red, green, blue) sub-pixels, such that overall average brightness and contrast ratio of LCD monitors may be enhanced. However, a conventional multi-primary color LCD remains receiving an RGB (red, green, blue) color input signal and obtaining a minimum color signal (min{R, G, B}) of the RGB color input signal so as to drive the W sub-pixel of the pixel.

That is, the R color input signal of the RGB color input signal is for driving the R sub-pixel of the pixel; the G color input signal of the RGB color input signal is for driving the G sub-pixel of the pixel; the B color input signal of the RGB color input signal is for driving the B sub pixel of the pixel; and the minimum color signal (min{R, G, B}) of the RGB color input signal is for driving the W sub-pixel of the pixel.

Accordingly, the driving manner of a conventional multi-primary color LCD may cause not only a decrease in chroma of the multi-primary color LCD, but also a decrease in color purity of a frame displayed by the multi-primary color LCD (i.e. a whitish frame).

### SUMMARY OF THE INVENTION

In view of the above, the invention provides a multi-primary color LCD and a color signal conversion device and method thereof, so as to resolve the above-described problems of the related art.

An embodiment of the invention provides a color signal conversion device suitable for a multi-primary color LCD, which includes a first color space conversion unit, a chroma compensation unit, and a second color space conversion unit. The first color space conversion unit is for receiving an RGB (red, green, blue) color input signal, and converting the RGB color input signal into a YUV (brightness-chroma) color signal. The chroma compensation unit is coupled to the first color space conversion unit, and is for performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal of the RGB color input signal. The second color space conversion unit is coupled to the chroma compensation unit, and is for receiving the compensated YUV color signal, and converting the compensated YUV color signal into an RGB color output signal.

In an embodiment of the invention, the color signal conversion device further includes: an output calibration unit coupled to the chroma compensation unit and the second color space conversion unit, wherein the output calibration unit is for deciding whether to calibrate the W color output signal and the RGB color output signal according to a plurality of parameters in connection with the RGB color output signal and the W color output signal, so as to output an RGBW (red, green, blue, white) color output signal.

Another embodiment of the invention provides a color signal conversion method suitable for a multi-primary color LCD, the color signal conversion method includes: converting an RGB (red, green, blue) color input signal into a YUV (brightness-chroma) color signal; performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal of the RGB color input signal; and converting the compensated YUV color signal into an RGB color output signal.

In an embodiment of the invention, the color signal conversion method further includes: deciding whether to calibrate the W color output signal and the RGB color output signal according to a plurality of parameters in connection with the RGB color output signal and the W color output signal, so as to output an RGBW (red, green, blue, white) color output signal.

Still another embodiment of the invention provides a multi-primary color LCD, which includes: an LCD panel, the above-mentioned color signal conversion device, a driving device, and a backlight module. The LCD panel has at least a pixel consisting of a red sub-pixel, a green sub-pixel, a blue sub-pixel, and a white sub-pixel. The driving device is coupled to the LCD panel and the color signal conversion device, and is for driving the red sub-pixel, green sub-pixel, blue sub-pixel, and white sub-pixel of the pixel according to the W color output signal and the RGB color output signal from the color signal conversion device, or according to the RGBW color output signal. The backlight module is for providing a backlight source required by the LCD panel.

Based on the above, the invention, according to a minimum color signal of an RGB color input signal and a brightness (Y) signal of a YUV color signal after a color space conversion, performs an adjustment/compensation on a chroma of a multi-primary color LCD (this action may enhance the chroma of the multi-primary color LCD), and calibrates the RGB color output signal and the W color output signal in an appropriate degree so as to enhance a color purity of a frame displayed by the multi-primary color LCD.

It should be understood that the above descriptions and the below embodiments are illustrative and exemplary and are not intended to limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic drawing of a multi-primary color LCD 10 according to an embodiment of the invention.

FIG. 2 illustrates a schematic drawing of a color signal conversion device 103 according to an embodiment of the invention.

FIG. 3 illustrates a schematic drawing of an output calibration unit 207 according to an embodiment of the invention.

FIG. 4 illustrates a schematic drawing of a parameter generator 301 according to an embodiment of the invention.

FIG. 5 illustrates a schematic drawing of a decision flow in connection with a predetermined maximum value (i.e. 255), a predetermined minimum value (i.e. 0), a W color output signal Wo′, and parameters Max, Min, V1, V2 and V3, according to an embodiment of the invention.

FIG. 6 illustrates a flow of a color signal conversion method suitable for a multi-primary color LCD according to an embodiment of the invention.

FIG. 7 illustrates a schematic drawing of performing a compensation on a chroma (UV) signal of a YUV color signal according to an embodiment of the invention.

FIG. 8 illustrates a schematic drawing of outputting an RGBW color output signal according to an embodiment of the invention.

FIG. 9 illustrates a schematic drawing of obtaining a plurality of parameters in connection with an RGB color output signal according to an embodiment of the invention.

### DETAILED DESCRIPTION OF THE EMBODIMENTS

The exemplary embodiments of the disclosure are illustrated in detail below with reference to the accompanying drawings. In addition, components/members of the same reference numerals are used to represent the same or similar parts in the accompanying drawings and implementations wherever it is possible.

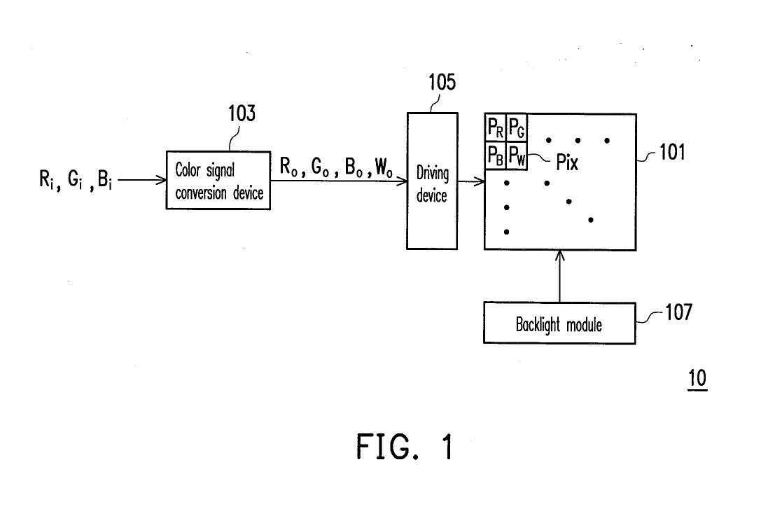

FIG. 1 illustrates a schematic drawing of a multi-primary color LCD 10 according to an embodiment of the invention. Referring to FIG. 1, the multi-primary color LCD 10 includes: an LCD panel 101, a color signal conversion device 103, a driving device 105, and a backlight module 107.

The LCD panel 101 has a plurality of pixels Pix arranged in a matrix form, each pixel Pix consists of red, green, blue and white sub-pixels, referred to as P_{R}, P_{G}, P_{B} and P_{W}. The backlight module 107 may be any form or type of current backlight module and is for providing a backlight source required by the LCD panel 101.

The color signal conversion device 103 is for receiving RGB (red, green, blue) color input signal Ri, Gi, Bi, and converting the RGB color input signal Ri, Gi, Bi so as to provide RGBW (red, green, blue, white) color output signal Ro, Go, Bo, Wo. Based on the above, the driving device 105 is coupled to the LCD panel 101 and the color signal conversion device 103, and is for driving the red, green, blue and white sub-pixels P_{R}, P_{G}, P_{B} and P_{W} of the pixel Pix according to the RGBW color output signal Ro, Go, Bo, Wo. In this embodiment, the driving device 105 may be an integrated IC equipped with multi-functions such as timing controller (T-con), scan driver, and source driver.

It can be inferred from the disclosure of the related art that a conventional multi-primary color LCD still remains receiving an RGB color input signal, and obtaining a minimum color signal (min{R, G, B}) of the RGB color input signal, so as to drive W (white) sub-pixel of the pixel. Thus, the driving manner of a conventional multi-primary color LCD may cause not only a decrease in chroma of the multi-primary color LCD, but also a decrease in color purity of a frame displayed by the multi-primary color LCD (i.e. a whitish frame).

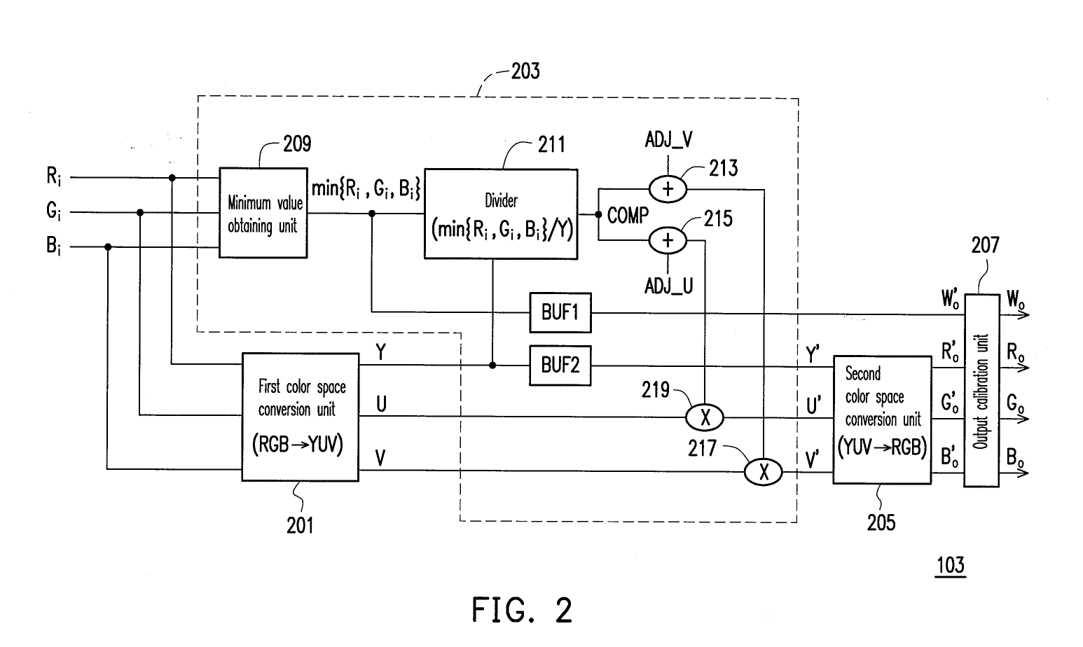

In light of the above, this embodiment may resolve the above-described problems of the related art by the color signal conversion device 103. More specifically, FIG. 2 illustrates a schematic drawing of a color signal conversion device 103 according to an embodiment of the invention. Referring to both FIG. 1 and FIG. 2, the color signal conversion device 103 includes: a first color space conversion unit 201, a chroma compensation unit 203, a second color space conversion unit 205, and an output calibration unit 207, wherein the first color space conversion unit (RGB→YUV) 201 is for receiving the RGB color input signal Ri, Gi, Bi, and converting the RGB color input signal Ri, Gi, Bi into a YUV (brightness-chroma) color signal Y, U, V.

The chroma compensation unit 203 is coupled to the first color space conversion unit 201, and is for providing a compensation on a chroma signal (UV) of the YUV color signal Y, U, V according to a minimum color signal of the RGB color input signal Ri, Gi, Bi and a brightness signal (Y) of the YUV color signal Y, U, V, so as to output a compensated YUV color signal Y′, U′, V′, and provide a W (white) color output signal Wo′ according to the minimum color signal of the RGB color input signal Ri, Gi, Bi.

More specifically, the chroma compensation unit 203 includes: a minimum value obtaining unit 209, a divider 211, a first adder 213, a second adder 215, a first multiplier 217, a second multiplier 219, a first buffer BUF1, and a second buffer BUF2, wherein the minimum value obtaining unit 209 is for receiving the RGB color input signal Ri, Gi, Bi, and obtaining the minimum color signal of the RGB color input signal Ri, Gi, Bi, i.e. min{Ri, Gi, Bi}.

The divider 211 is coupled to the first color space conversion unit 201 and the minimum value obtaining unit 209, and is for performing a division operation on the minimum color signal of the RGB color input signal Ri, Gi, Bi (min{Ri, Gi, Bi}) and the brightness signal (Y) of the YUV color signal Y, U, V, so as to output a compensation ratio value COMP, i.e. min{Ri, Gi, Bi}/Y.

The first adder 213 is coupled to the divider 211, and is for performing an addition operation on the compensation ratio value COMP outputted by the divider 211 and an adjustable V color difference signal ADJ_V, so as to output a first accumulated value, i.e. COMP+ADJ_V. The second adder 215 is coupled to the divider 211, and is for performing an addition operation on the compensation ratio value COMP outputted by the divider 211 and an adjustable U color difference signal ADJ_U, so as to output a second accumulated value, i.e. COMP+ADJ_U.

The first multiplier 217 is coupled to the first color space conversion unit 201 and the first adder 213, and is for performing a multiplication operation on the first accumulated value (COMP+ADJ_V) outputted by the first adder 213 and an original V color difference signal V of the chroma signal (UV) of the YUV color signal Y, U, V, so as to output a compensation V color difference signal V′, i.e. (COMP+ADJ_V)*V. The second multiplier 219 is coupled to the first color space conversion unit 201 and the second adder 215, and is for performing a multiplication operation on the second accumulated value (COMP+ADJ_U) outputted by the second adder 213 and an original U color difference signal U of the chroma signal (UV) of the YUV color signal Y, U, V, so as to output a compensation U color difference signal U′, i.e. (COMP+ADJ_U)*U.

The first buffer BUF1 is coupled to the first color space conversion unit 201, and is for receiving and buffering the brightness signal (Y) of the YUV color signal Y, U, V, so as to output a compensation brightness signal Y′. In this embodiment, the compensation brightness signal Y′, the compensation V color difference signal V′ and the compensation U color difference signal U′ form the compensated YUV color signal Y′, U′, V′. The second buffer BUF2 is coupled to the minimum value obtaining unit 209, and is for receiving and buffering the minimum color signal of the RGB color input signal Ri, Gi, Bi (i.e. min {Ri, Gi, Bi}), so as to provide the W color output signal Wo′ (i.e. Wo′=min{Ri, Gi, Bi}).

On the other hand, the second color space conversion unit (YUV-RGB) 205 is coupled to the chroma compensation unit 203, and is for receiving the compensated YUV color signal Y′, U′, V′ and converting the compensated YUV color signal Y′, U′, V′ into a RGB color output signal Ro′, Go′, Bo′. Based on the above, the output calibration unit 207 is coupled to the chroma compensation unit 203 and the second color space conversion unit 205, and is for deciding whether to calibrate the W color output signal Wo′ and the RGB color output signal Ro′, Go′, Bo′ according to a plurality of parameters in connection with the RGB color output signal Ro′, Go′, Bo′ and the W color output signal Wo′, so as to output the RGBW color output signal Ro, Go, Bo, Wo.

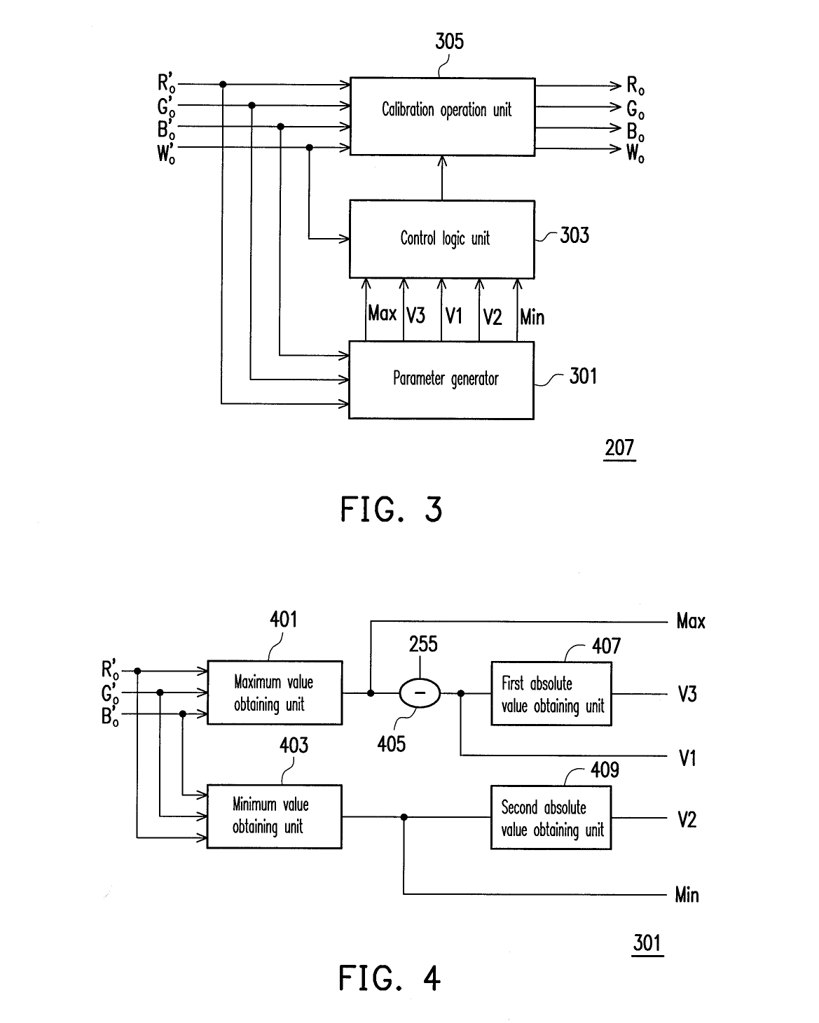

More specifically, FIG. 3 illustrates a schematic drawing of the output calibration unit 207 according to an embodiment of the invention. Referring to FIG. 1 to FIG. 3, the output calibration unit 207 includes: a parameter generator 301, a control logic unit 303, and a calibration operation unit 305. The parameter generator 301 is coupled to the second color space conversion unit 205, and is for receiving the RGB color output signal Ro′, Go′, Bo′, so as to obtain a plurality of parameters, Max, Min, V1, V2 and V3, in connection with the RGB color output signal Ro′, Go′, Bo′.

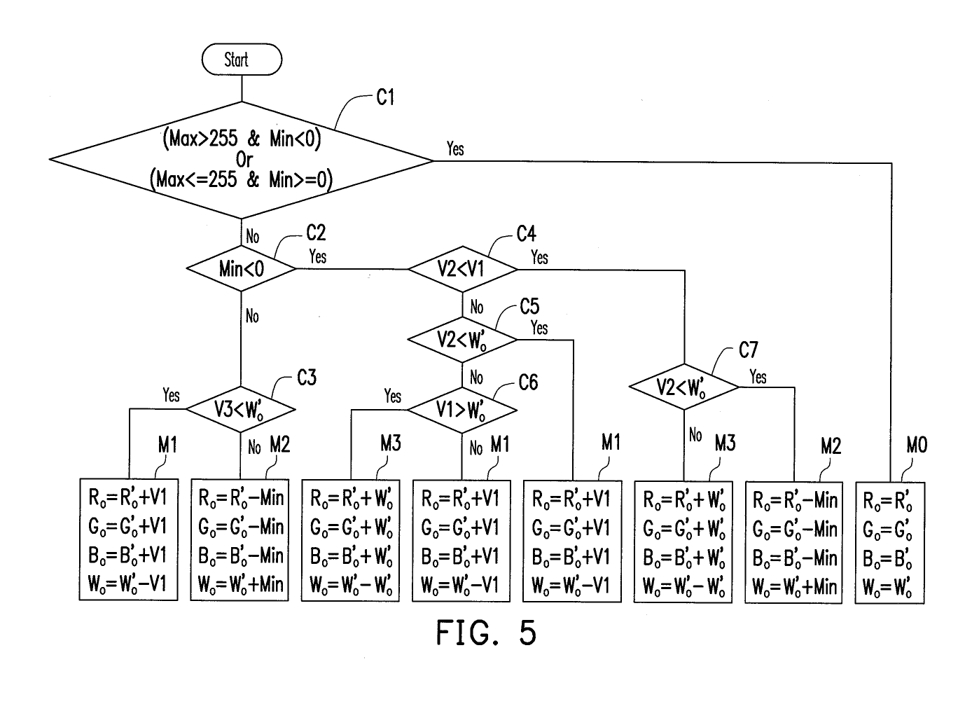

This embodiment is as shown in FIG. 4, which illustrates a schematic drawing of the parameter generator 301 according to an embodiment of the invention. Referring to FIG. 4, the parameter generator 301 includes: a maximum value obtaining unit 401, a minimum value obtaining unit 403, a subtracter 405, a first absolute value obtaining unit 407, and a second absolute value obtaining unit 409. The maximum value obtaining unit 401 is coupled to the second color space conversion unit 205, and is for receiving the RGB color output signal Ro′, Go′, Bo′, and obtaining a maximum color signal (i.e. max{Ro′, Go′, Bo′}) of the RGB color output signal Ro′, Go′, Bo′ as the parameter Max.

The minimum value obtaining unit 403 is coupled to the second color space conversion unit 205, and is for receiving the RGB color output signal Ro′, Go′, Bo′, and obtaining a minimum color signal (i.e. min{Ro′, Go′, Bo′}) of the RGB color output signal Ro′, Go′, Bo′ as the parameter Min. The subtracter 405 is coupled to the maximum value obtaining unit 401, and is for performing a subtraction operation on a predetermined maximum value (for example, 255, in a case with 8-bit pixel resolution, but the disclosure is not limited thereto) and the maximum color signal (max{Ro′, Go′, Bo′}) of the RGB color output signal Ro′, Go′, Bo′, so as to output a difference value (i.e. 255−max{Ro′, Go′, Bo′} as the parameter V1. The first absolute value obtaining unit 407 is coupled to the subtracter 405, and is for obtaining an absolute value of the difference value (255−max{Ro′, Go′, Bo′}) outputted by the subtracter 405 as the parameter V3. The second absolute value obtaining unit 409 is coupled to the minimum value obtaining unit 403, and is for obtaining an absolute value of the minimum color signal (min{Ro′, Go′, Bo′}) of the RGB color output signal Ro′, Go′, Bo′ as the parameter V2.

On the other hand, the control logic unit 303 is coupled to the chroma compensation unit 203 and the parameter generator 301, and is for deciding whether to calibrate the W color output signal Wo′ and the RGB color output signal Ro′, Go′, Bo′ according to the W color output signal Wo′ and the parameters Max, Min, V1, V2 and V3 obtained by the parameter generator 301, so as to provide a calibration mode. In this embodiment, the control logic unit 303 may further decide whether to calibrate the W color output signal Wo′ and the RGB color output signal Ro′, Go′, Bo′ according to a decision flow in connection with the predetermined maximum value (i.e. 255), the predetermined minimum value (for example, 0, in a case with 8-bit pixel resolution, but the disclosure is not limited thereto), the W color output signal Wo′ and the parameters Max, Min, V1, V2 and V3, so as to provide the calibration mode.

Based on the above, the calibration operation unit 305 is coupled to the chroma compensation unit 203, the second color space conversion unit 205 and the control logic unit 303, and is for performing an operation process on the W color output signal Wo′ and the RGB color output signal Ro′, Go′, Bo′ according to the calibration mode provided by the control logic unit 303, so as to output the RGBW color output signal Ro, Go, Bo, Wo.

More specifically, FIG. 5 illustrates a schematic drawing of the decision flow in connection with the predetermined maximum value (i.e. 255), the predetermined minimum value (i.e. 0), the W color output signal Wo′, and the parameters Max, Min, V1, V2 and V3, according to an embodiment of the invention. Referring to FIG. 5, if the control logic unit 303 decides that the parameter Max is greater than the predetermined maximum value (i.e. 255) and the parameter Min is smaller than the predetermined minimum value (i.e. 0), or that the parameter Max is equal to or smaller than the predetermined maximum value (i.e. 255) and the parameter Min is equal to or greater than the predetermined minimum value (i.e. 0) (i.e. the decision condition C1 is satisfied), the control logic unit 303 would provide the calibration operation unit 305 with a calibration mode M0 which indicates no change. Accordingly, the calibration operation unit 305 would perform an operation process on the W color output signal Wo′ and the RGB color output signal Ro′, Go′, Bo′ according to the calibration mode M0, so as to output the RGBW color output signal Ro, Go, Bo, Wo, i.e. Ro=Ro′±0; Go=Go′±0; Bo=Bo′±0 and Wo=Wo′±0.

Under a condition wherein the decision condition C1 is not satisfied, if the control logic unit 303 decides that the parameter Min is greater than the predetermined minimum value (i.e. 0) (i.e. the decision condition C2 is not satisfied), and the W color output signal Wo′ is greater than the parameter V3 (i.e. the decision condition C3 is satisfied), the control logic unit 303 would provide the calibration operation unit 305 with a calibration mode M1 which indicates a first compensation. Accordingly, the calibration operation unit 305 would perform an operation process on the W color output signal Wo′ and the RGB color output signal Ro′, Go′, Bo′ according to the calibration mode M1 of the first compensation, so as to output the RGBW color output signal Ro, Go, Bo, Wo, i.e. Ro=Ro′+V1; Go=Go′+V1; Bo=Bo′+V1 and Wo=Wo′−V1.

Under a condition wherein the decision condition C1 is not satisfied, if the control logic unit 303 decides that the parameter Min is greater than the predetermined minimum value (i.e. 0) (i.e. the decision condition C2 is not satisfied), and the W color output signal Wo′ is smaller than the parameter V3 (i.e. the decision condition C3 is not satisfied), the control logic unit 303 would provide the calibration operation unit 305 with a calibration mode M2 which indicates a second compensation. Accordingly, the calibration operation unit 305 would perform an operation process on the W color output signal Wo′ and the RGB color output signal Ro′, Go′, Bo′ according to the calibration mode M2 of the second compensation, so as to output the RGBW color output signal Ro, Go, Bo, Wo, i.e. Ro=Ro′−Min; Go=Go′−Min; Bo=Bo′−Min and Wo=Wo′+Min.

Under a condition wherein the decision condition C1 is not satisfied, if the control logic unit 303 decides that the parameter Min is smaller than the predetermined minimum value (i.e. 0) (i.e. the decision condition C2 is satisfied), the parameter V2 is greater than the parameter V1 (i.e. the decision condition C4 is not satisfied), the W color output signal Wo′ is smaller than the parameter V2 (i.e. the decision condition C5 is not satisfied), and the W color output signal Wo′ is smaller than the parameter V1 (i.e. the decision condition C6 is satisfied), the control logic unit 303 would provide the calibration operation unit 305 with a calibration mode M3 which indicates a third compensation. Accordingly, the calibration operation unit 305 would perform an operation process on the W color output signal Wo′ and the RGB color output signal Ro′, Go′, Bo′ according to the calibration mode M3 of the third compensation, so as to output the RGBW color output signal Ro, Go, Bo, Wo, i.e. Ro=Ro′+Wo′; Go=Go′+Wo′; Bo=Bo′+Wo′ and Wo=Wo′−Wo′.

Under a condition wherein the decision condition C1 is not satisfied, if the control logic unit 303 decides that the parameter Min is smaller than the predetermined minimum value (i.e. 0) (i.e. the decision condition C2 is satisfied), the parameter V2 is greater than the parameter V1 (i.e. the decision condition C4 is not satisfied), the W color output signal Wo′ is smaller than the parameter V2 (i.e. the decision condition C5 is not satisfied), and the W color output signal Wo′ is greater than the parameter V1 (i.e. the decision condition C6 is not satisfied), the control logic unit 303 would provide the calibration operation unit 305 with the calibration mode M1 which indicates the first compensation. Accordingly, the calibration operation unit 305 would perform an operation process on the W color output signal Wo′ and the RGB color output signal Ro′, Go′, Bo′ according to the calibration mode M1 of the first compensation, so as to output the RGBW color output signal Ro, Go, Bo, Wo, i.e. Ro=Ro′+V1; Go=Go′+V1; Bo=Bo′ V1 and Wo=Wo′−V1.

Under a condition wherein the decision condition C1 is not satisfied, if the control logic unit 303 decides that the parameter Min is smaller than the predetermined minimum value (i.e. 0) (i.e. the decision condition C2 is satisfied), the parameter V2 is greater than the parameter V1 (i.e. the decision condition C4 is not satisfied), and the W color output signal Wo′ is greater than the parameter V2 (i.e. the decision condition C5 is satisfied), the control logic unit 303 would provide the calibration operation unit 305 with the calibration mode M1 which indicates the first compensation. Accordingly, the calibration operation unit 305 would perform an operation process on the W color output signal Wo′ and the RGB color output signal Ro′, Go′, Bo′ according to the calibration mode M1 of the first compensation, so as to output the RGBW color output signal Ro, Go, Bo, Wo, i.e. Ro=Ro′+V1; Go=Go′+V1; Bo=Bo′+V1 and Wo=Wo′−V1.

Under a condition wherein the decision condition C1 is not satisfied, if the control logic unit 303 decides that the parameter Min is smaller than the predetermined minimum value (i.e. 0) (i.e. the decision condition C2 is satisfied), the parameter V2 is smaller than the parameter V1 (i.e. the decision condition C4 is satisfied), and the W color output signal Wo′ is smaller than the parameter V2 (i.e. the decision condition C7 is not satisfied), the control logic unit 303 would provide the calibration operation unit 305 with the calibration mode M3 which indicates the third compensation. Accordingly, the calibration operation unit 305 would perform an operation process on the W color output signal Wo′ and the RGB color output signal Ro′, Go′, Bo′ according to the calibration mode M3 of the third compensation, i.e. Ro=Ro′+Wo′; Go=Go′ Wo′; Bo=Bo′±Wo′ and Wo=Wo′−Wo′.

Under a condition wherein the decision condition C1 is not satisfied, if the control logic unit 303 decides that the parameter Min is smaller than the predetermined minimum value (i.e. 0) (i.e. the decision condition C2 is satisfied), the parameter V2 is smaller than the parameter V1 (i.e. the decision condition C4 is satisfied), and the W color output signal Wo′ is greater than the parameter V2 (i.e. the decision condition C7 is satisfied), the control logic unit 303 would provide the calibration operation unit 305 with the calibration mode M2 which indicates the second compensation. Accordingly, the calibration operation unit 305 would perform an operation process on the W color output signal Wo′ and the RGB color output signal Ro′, Go′, Bo′ according to the calibration mode M2 of the second compensation, so as to output the RGBW color output signal Ro, Go, Bo, Wo, i.e. Ro=Ro′−Min; Go=Go′−Min; Bo=Bo′−Min and Wo=Wo′+Min.

Based on the decision flow shown in FIG. 5, it can be clearly obtained that since the chroma compensation unit 203 is mainly for compensating/adjusting the chroma signal (UV) of the YUV color signal Y, U, V (this action may enhance the chroma of the multi-primary color LCD 10), after the conversion by the second color space conversion unit (YUV→RGB) 205, it is possible that the RGB color output signal Ro′, Go′, Bo′ may exceed the upper limit of the range in which they can be displayed (i.e. greater than the predetermined maximum value 255) or the lower limit thereof (i.e. smaller than the predetermined minimum value 0). Based on the above, if the part of the RGB color output signal Ro′, Go′, Bo′ exceeding the range in which they can be displayed is directly deleted, an error in the specific gravity of the RGB color output signal Ro′, Go′, Bo′ may be caused, resulting in color distortion.

In view of the above, this embodiment is specially designed to calibrate the part of the RGB color output signal Ro′, Go′, Bo′ exceeding the range in which they can be displayed (i.e. the part greater than the predetermined maximum value 255 and/or smaller than the predetermined minimum value 0) by a mechanism/method of adjusting the W color output signal Wo′ through the output calibration unit 207. Accordingly, through appropriate calibration of the RGB color output signal Ro′, Go′, Bo′ and the W color output signal Wo′ by the output calibration unit 207, the color purity of a frame displayed by the multi-primary color LCD 10 may be significantly enhanced.

Certainly, if it can be ensured that the RGB color output signal Ro′, Go′, Bo′ will not exceed the upper limit of the range in which they can be displayed (i.e. greater than the predetermined maximum value 255) or the lower limit thereof (i.e. smaller than the predetermined minimum value 0), the output calibration unit 207 may be omitted, and the RGB color output signal Ro′, Go′, Bo′ and the W color output signal Wo′ may be directly viewed as the RGBW color output signal Ro, Go, Bo, Wo.

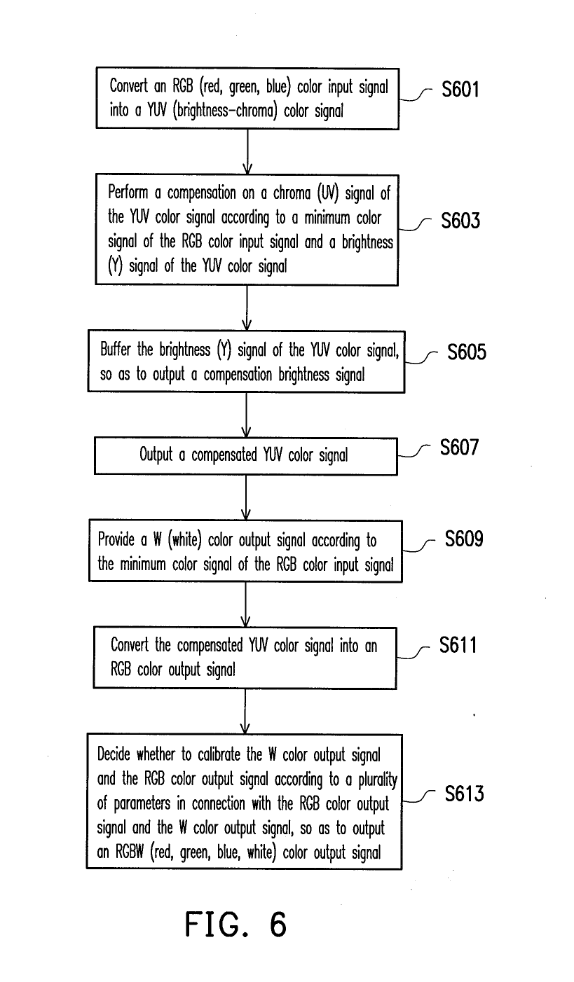

Based on the content disclosed/taught by each of the above embodiments, FIG. 6 illustrates a flow of a color signal conversion method suitable for a multi-primary color LCD according to an embodiment of the invention. Referring to FIG. 6, the color signal conversion method suitable for a multi-primary color LCD of this embodiment includes the following steps.

Converting an RGB (red, green, blue) color input signal into a YUV (brightness-chroma) color signal (step S601).

Performing a compensation on a chroma (UV) signal of the YUV color signal according to a minimum color signal of the RGB color input signal and a brightness (Y) signal of the YUV color signal (step S603).

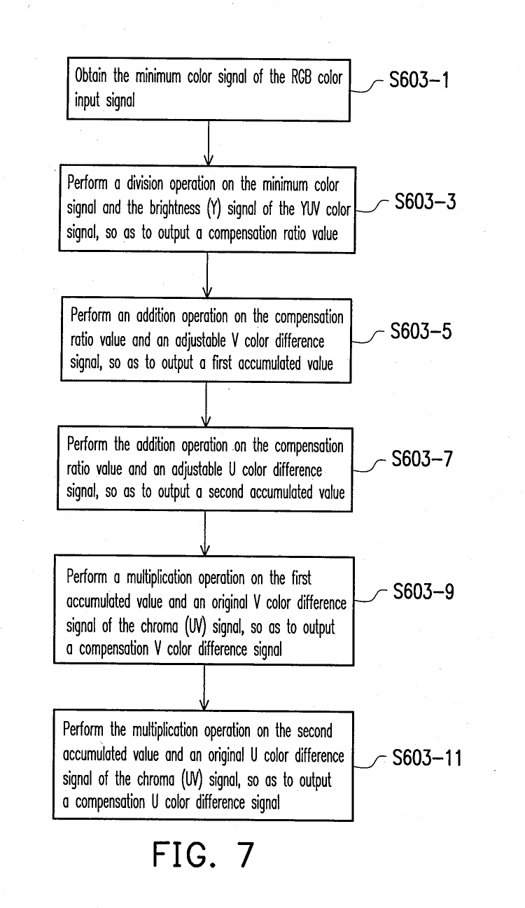

More specifically, as shown in FIG. 7, the step of performing the compensation on the chroma (UV) signal of the YUV color signal may include:

Obtaining the minimum color signal of the RGB color input signal (step S603-1);

Performing a division operation on the minimum color signal of the RGB color input signal and the brightness (Y) signal of the YUV color signal, so as to output a compensation ratio value (step S603-3);

Performing an addition operation on the compensation ratio value and an adjustable V color difference signal, so as to output a first accumulated value (step S603-5);

Performing the addition operation on the compensation ratio value and an adjustable U color difference signal, so as to output a second accumulated value (step S603-7);

Performing a multiplication operation on the first accumulated value and an original V color difference signal of the chroma (UV) signal, so as to output a compensation V color difference signal (step S603-9); and

Performing the multiplication operation on the second accumulated value and an original U color difference signal of the chroma (UV) signal, so as to output a compensation U color difference signal (step S603-11).

After performing the compensation on the chroma (UV) signal of the YUV color signal, buffering the brightness (Y) signal of the YUV color signal, so as to output a compensation brightness signal (step S605), and then output a compensated YUV color signal (step S607), wherein the compensated YUV color signal is formed by/composed of the compensation brightness signal, the compensation V color difference signal, and the compensation U color difference signal.

After outputting the compensated YUV color signal, providing a W (white) color output signal according to the minimum color signal of the RGB color input signal (step S609), for example, buffering the minimum color signal of the RGB color input signal.

After providing the W (white) color output signal, converting the compensated YUV color signal into an RGB color output signal (step S611), and deciding whether to calibrate the W color output signal and the RGB color output signal according to a plurality of parameters in connection with the RGB color output signal and the W color output signal, so as to output an RGBW (red, green, blue, white) color output signal (step S613).

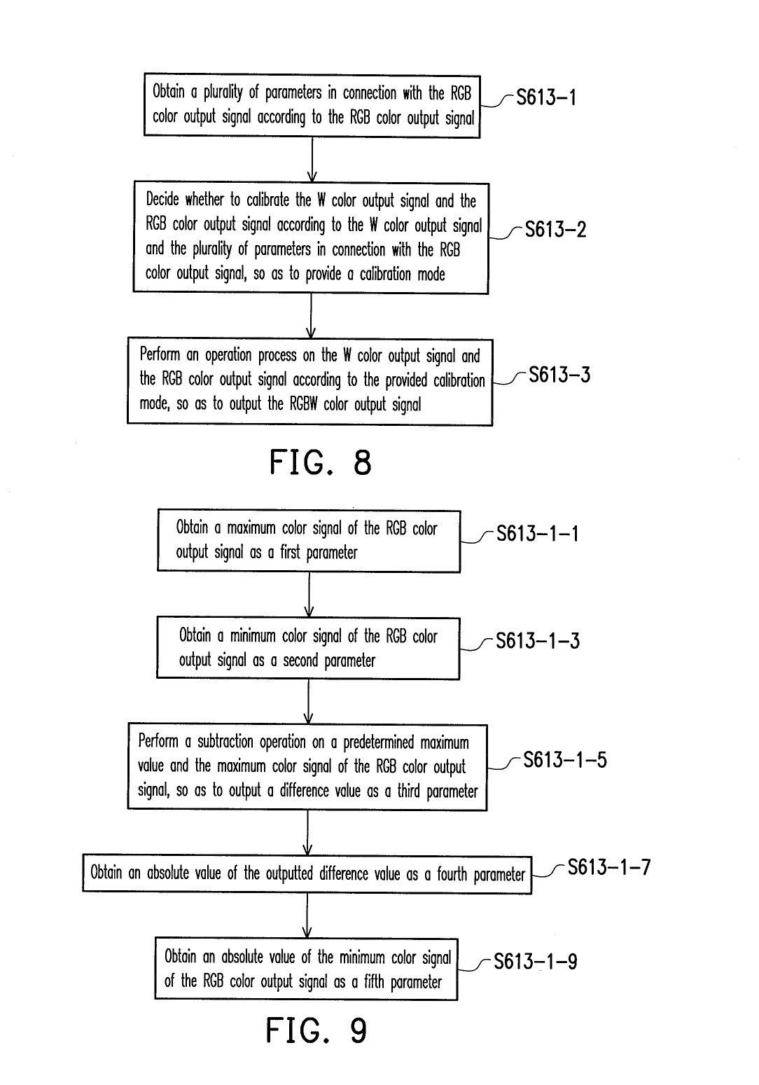

In this embodiment, as shown in FIG. 8, the step of outputting the RGBW color output signal may include:

Obtaining the plurality of parameters in connection with the RGB color output signal according to the RGB color output signal (step S613-1);

Deciding whether to calibrate the W color output signal and the RGB color output signal according to the W color output signal and the plurality of parameters in connection with the RGB color output signal, so as to provide a calibration mode (step S613-3); and

Performing an operation process on the W color output signal and the RGB color output signal according to the provided calibration mode, so as to output the RGBW color output signal (step S613-5).

On the other hand, as shown in FIG. 9, the step of obtaining the plurality of parameters in connection with the RGB color output signal may include:

Obtaining a maximum color signal of the RGB color output signal as a first parameter (step S613-1-1);

Obtaining a minimum color signal of the RGB color output signal as a second parameter (step S613-1-3);

Performing a subtraction operation on a predetermined maximum value and the maximum color signal of the RGB color output signal, so as to output a difference value as a third parameter (step S613-1-5);

Obtaining an absolute value of the outputted difference value as a fourth parameter (step S613-1-7); and

Obtaining an absolute value of the minimum color signal of the RGB color output signal as a fifth parameter (step S613-1-9).

In addition, the step of providing the calibration mode in step S613-3 may include: deciding and providing the calibration mode according to a decision flow in connection with the predetermined maximum value, the predetermined minimum value, the W color output signal and the first to fifth parameters. Certainly, the decision flow described herein may be similar to FIG. 5, and thus an explanation is omitted.

In conclusion to the above, the invention, according to a minimum color signal of an RGB color input signal and a brightness (Y) signal of a YUV color signal after a color space conversion, performs an adjustment/compensation on a chroma of a multi-primary color LCD (this action may enhance the chroma of the multi-primary color LCD), and calibrates a W color output signal and the RGB color output signal in an appropriate degree so as to enhance a color purity of a frame displayed by the multi-primary color LCD.

Though the invention has been disclosed above by the embodiments, they are not intended to limit the invention. It will be apparent to one of ordinary skill in the art that modifications and variations to the described embodiments may be made without departing from the spirit and scope of the invention. Therefore, the protecting range of the invention falls in the appended claims. Additionally, any embodiment or claim of the invention does not need to attain all of the advantages or features disclosed in the invention. The abstract and title are merely used for facilitating the search for patent documents, and the scope of the invention is not limited thereto.

What is claimed is:

1. A color signal conversion device suitable for a multi-primary color LCD, the color signal conversion device comprising:
a first color space conversion unit, for receiving an RGB (red, green, blue) color input signal, and converting the RGB color input signal into a YUV (brightness-chroma) color signal;
a chroma compensation unit coupled to the first color space conversion unit, for performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal; and
a second color space conversion unit coupled to the chroma compensation unit, for receiving the compensated YUV color signal, and converting the compensated YUV color signal into an RGB color output signal.

2. The color signal conversion device as claimed in claim 1, wherein the chroma compensation unit comprises:
a minimum value obtaining unit, for receiving the RGB color input signal, and obtaining the minimum color signal of the RGB color input signal;
a divider coupled to the first color space conversion unit and the minimum value obtaining unit, for performing a division operation on the minimum color signal and the brightness signal, so as to output a compensation ratio value;
a first adder coupled to the divider, for performing an addition operation on the compensation ratio value and an adjustable V color difference signal, so as to output a first accumulated value;
a second adder coupled to the divider, for performing the addition operation on the compensation ratio value and an adjustable U color difference signal, so as to output a second accumulated value;
a first multiplier coupled to the first color space conversion unit and the first adder, for performing a multiplication operation on the first accumulated value and an original V color difference signal of the chroma signal, so as to output a compensation V color difference signal;
a second multiplier coupled to the first color space conversion unit and the second adder, for performing the multiplication operation on the second accumulated value and an original U color difference signal of the chroma signal, so as to output a compensation U color difference signal;
a first buffer coupled to the first color space conversion unit, for receiving and buffering the brightness (Y) signal, so as to output a compensation brightness signal, wherein the compensation brightness signal, the compensation V color difference signal, and the compensation U color difference signal form the compensated YUV color signal; and
a second buffer coupled to the minimum value obtaining unit, for receiving and buffering the minimum color signal, so as to provide the W color output signal.

3. The color signal conversion device as claimed in claim 1, further comprising:
an output calibration unit coupled to the chroma compensation unit and the second color space conversion unit, for deciding whether to calibrate the W color output signal and the RGB color output signal according to a plurality of parameters in connection with the RGB color output signal and the W color output signal, so as to output an RGBW (red, green, blue, white) color output signal.

4. The color signal conversion device as claimed in claim 3, wherein the output calibration unit comprises:
a parameter generator coupled to the second color space conversion unit, for receiving the RGB color output signal, so as to obtain the parameters;
a control logic unit coupled to the chroma compensation unit and the parameter generator, for deciding whether to calibrate the W color output signal and the RGB color output signal according to the W color output signal and the parameters, so as to provide a calibration mode; and
a calibration operation unit coupled to the chroma compensation unit, the second color space conversion unit, and the control logic unit, for performing an operation process on the W color output signal and the RGB color output signal according to the calibration mode, so as to output the RGBW color output signal.

5. The color signal conversion device as claimed in claim 4, wherein the parameter generator comprises:
a maximum value obtaining unit coupled to the second color space conversion unit, for receiving the RGB color output signal, and obtaining a maximum color signal of the RGB color output signal as a first parameter;
a minimum value obtaining unit coupled to the second color space conversion unit, for receiving the RGB color output signal, and obtaining a minimum color signal of the RGB color output signal as a second parameter;
a subtracter coupled to the maximum value obtaining unit, for performing a subtraction operation on a predetermined maximum value and the maximum color signal, so as to output a difference value as a third parameter;
a first absolute value obtaining unit coupled to the subtracter, for obtaining an absolute value of the difference value as a fourth parameter; and
a second absolute value obtaining unit coupled to the minimum value obtaining unit, for obtaining an absolute value of the minimum color signal as a fifth parameter.

6. The color signal conversion device as claimed in claim 5, wherein the control logic unit further decides whether to calibrate the W color output signal and the RGB color output signal according to a decision flow in connection with the predetermined maximum value, a predetermined minimum value, the W color output signal, and the first to fifth parameters, so as to provide the calibration mode.

7. A color signal conversion method suitable for a multi-primary color LCD, the color signal conversion method comprising:
converting an RGB (red, green, blue) color input signal into a YUV (brightness-chroma) color signal;
performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal; and
converting the compensated YUV color signal into an RGB color output signal.

8. The color signal conversion method as claimed in claim 7, wherein the step of performing the compensation on the chroma (UV) signal comprises:
obtaining the minimum color signal of the RGB color input signal;
performing a division operation on the minimum color signal and the brightness signal, so as to output a compensation ratio value;
performing an addition operation on the compensation ratio value and an adjustable V color difference signal, so as to output a first accumulated value;
performing the addition operation on the compensation ratio value and an adjustable U color difference signal, so as to output a second accumulated value;
performing a multiplication operation on the first accumulated value and an original V color difference signal of the chroma signal, so as to output a compensation V color difference signal; and
performing the multiplication operation on the second accumulated value and an original U color difference signal of the chroma signal, so as to output a compensation U color difference signal.

9. The color signal conversion method as claimed in claim 7, wherein before the step of outputting the compensated YUV color signal, the color signal conversion method further comprises:
buffering the brightness (Y) signal, so as to output a compensation brightness signal,
wherein the compensation brightness signal, the compensation V color difference signal, and the compensation U color difference signal form the compensated YUV color signal.

10. The color signal conversion method as claimed in claim 7, wherein the step of providing the W color output signal comprises:
buffering the minimum color signal, so as to provide the W color output signal.

11. The color signal conversion method as claimed in claim 7, further comprising:
deciding whether to calibrate the W color output signal and the RGB color output signal according to a plurality of parameters in connection with the RGB color output signal and the W color output signal, so as to output an RGBW (red, green, blue, white) color output signal.

12. The color signal conversion method as claimed in claim 11, wherein the step of outputting the RGBW color output signal comprises:
obtaining the parameters according to the RGB color output signal;
deciding whether to calibrate the W color output signal and the RGB color output signal according to the W color output signal and the parameters, so as to provide a calibration mode; and
performing an operation process on the W color output signal and the RGB color output signal according to the calibration mode, so as to output the RGBW color output signal.

13. The color signal conversion method as claimed in claim 12, wherein the step of obtaining the parameters comprises:
obtaining a maximum color signal of the RGB color output signal as a first parameter;
obtaining a minimum color signal of the RGB color output signal as a second parameter;
performing a subtraction operation on a predetermined maximum value and the maximum color signal, so as to output a difference value as a third parameter;
obtaining an absolute value of the difference value as a fourth parameter; and
obtaining an absolute value of the minimum color signal as a fifth parameter.

14. The color signal conversion method as claimed in claim 13, wherein the step of providing the calibration mode comprises:
deciding and providing the calibration mode according to a decision flow in connection with the predetermined maximum value, a predetermined minimum value, the W color output signal, and the first to fifth parameters.

15. A multi-primary color LCD comprising:
an LCD panel having at least a pixel consisting of a red sub-pixel, a green sub-pixel, a blue sub-pixel and a white sub-pixel;
a color signal conversion device comprising:
a first color space conversion unit, for receiving an RGB (red, green, blue) color input signal, and converting the RGB color input signal into a YUV (brightness-chroma) color signal;
a chroma compensation unit coupled to the first color space conversion unit, for performing a compensation on a chroma (UV) signal of the YUV color signal according to a minimum color signal of the RGB color input signal and a brightness (Y) signal of the YUV color signal, so as to output a compensated YUV color signal, and providing a W (white) color output signal according to the minimum color signal; and
a second color space conversion unit coupled to the chroma compensation unit, for receiving the compensated YUV color signal, and converting the compensated YUV color signal into an RGB color output signal;
a driving device coupled to the LCD panel and the color signal conversion device, for driving the red sub-pixel, the green sub-pixel, the blue sub-pixel, and the white sub-pixel of the pixel according to the W color output signal and the RGB color output signal; and
a backlight module, for providing a backlight source required by the LCD panel.

16. The multi-primary color LCD as claimed in claim 15, wherein the chroma compensation unit comprises:
a minimum value obtaining unit, for receiving the RGB color input signal, and obtaining the minimum color signal of the RGB color input signal;
a divider coupled to the first color space conversion unit and the minimum value obtaining unit, for performing a division operation on the minimum color signal and the brightness signal, so as to output a compensation ratio value;
a first adder coupled to the divider, for performing an addition operation on the compensation ratio value and an adjustable V color difference signal, so as to output a first accumulated value;
a second adder coupled to the divider, for performing the addition operation on the compensation ratio value and an adjustable U color difference signal, so as to output a second accumulated value;
a first multiplier coupled to the first color space conversion unit and the first adder, for performing a multiplication operation on the first accumulated value and an original V color difference signal of the chroma signal, so as to output a compensation V color difference signal;
a second multiplier coupled to the first color space conversion unit and the second adder, for performing the multiplication operation on the second accumulated value and an original U color difference signal of the chroma signal, so as to output a compensation U color difference signal;
a first buffer coupled to the first color space conversion unit, for receiving and buffering the brightness (Y) signal, so as to output a compensation brightness signal, wherein the compensation brightness signal, the compensation V color difference signal, and the compensation U color difference signal form the compensated YUV color signal; and
a second buffer coupled to the minimum value obtaining unit, for receiving and buffering the minimum color signal, so as to provide the W color output signal.

17. The multi-primary color LCD as claimed in claim 15, wherein the color signal conversion device further comprises:
an output calibration unit coupled to the chroma compensation unit and the second color space conversion unit, for deciding whether to calibrate the W color output signal and the RGB color output signal according to a plurality of parameters in connection with the RGB color output signal and the W color output signal, so as to output an RGBW (red, green, blue, white) color output signal,
wherein the driving device further drives the red sub-pixel, green sub-pixel, blue sub-pixel, and white sub-pixel of the pixel according to the RGBW color output signal.

18. The multi-primary color LCD as claimed in claim 17, wherein the output calibration unit comprises:
a parameter generator coupled to the second color space conversion unit, for receiving the RGB color output signal, so as to obtain the parameters;
a control logic unit coupled to the chroma compensation unit and the parameter generator, for deciding whether to calibrate the W color output signal and the RGB color output signal according to the W color output signal and the parameters, so as to provide a calibration mode; and
a calibration operation unit coupled to the chroma compensation unit, the second color space conversion unit, and the control logic unit, for performing an operation process on the W color output signal and the RGB color output signal according to the calibration mode, so as to output the RGBW color output signal.

19. The multi-primary color LCD as claimed in claim 18, wherein the parameter generator comprises:
a maximum value obtaining unit coupled to the second color space conversion unit, for receiving the RGB color output signal, and obtaining a maximum color signal of the RGB color output signal as a first parameter;
a minimum value obtaining unit coupled to the second color space conversion unit, for receiving the RGB color output signal, and obtaining a minimum color signal of the RGB color output signal as a second parameter;
a subtracter coupled to the maximum value obtaining unit, for performing a subtraction operation on a predetermined maximum value and the maximum color signal, so as to output a difference value as a third parameter;
a first absolute value obtaining unit coupled to the subtracter, for obtaining an absolute value of the difference value as a fourth parameter; and
a second absolute value obtaining unit coupled to the minimum value obtaining unit, for obtaining an absolute value of the minimum color signal as a fifth parameter.

20. The multi-primary color LCD as claimed in claim 19, wherein the control logic unit further decides whether to calibrate the W color output signal and the RGB color output signal according to a decision flow in connection with the predetermined maximum value, a predetermined minimum value, the W color output signal, and the first to fifth parameters, so as to provide the calibration mode.
